(19) United States
(12) Patent Application Publication
(10) Pub. No.: US 2010/0118351 A1
(43) Pub. Date: May 13, 2010

(54) Image reading device and controlling program of the same

(75) Inventor: Kazuo Nakazawa, Tokyo (JP)

Correspondence Address: POSZ LAW GROUP, PLC, 12040 SOUTH LAKES DRIVE, SUITE 101, RESTON, VA, 20191, US

(73) Assignee: Oki Data Corporation, Tokyo (JP)

(21) Appl. No.: 12/591,028

(22) Filed: Nov. 5, 2009

(30) Foreign Application Priority Data
Nov. 7, 2008 (JP) 2008-286257

(51) Int. Cl. H04N 1/00

(52) U.S. Cl. 358/402; 345/168

(57) ABSTRACT

An image reading device that is connected to a communication network, that converts image information read by an image information reading part into sent image information, and that sends the sent image information over the communication network, the image reading device includes: a user identification (ID) information memory part configured to store user identification (ID) information; a controller configured to format source specific information (for example, email address, source fax number, and user TSI information) that is added to the image information based on the user ID information, the source specific information for identifying a user of the image reading device on a destination side at which the sent image information is received.

### CROSS REFERENCE TO RELATED APPLICATION

The invention is related to, claims priority from, and incorporates by reference Japanese patent application number 2008-286257, filed on Nov. 7, 2008.

### TECHNICAL FIELD

The present invention is related to an image reading device and a program for sending image information for the device. Particularly, it is related to an image reading device and a controlling program by which read images are sent in email or facsimile format.

### BACKGROUND

An email system is configured to store extra files in an email server and to implement email sending processing (or transmission processing) with attaching the extra data as attachment files. The attachment files are, for example, document files that are produced by a word processor in a personal computer (PC), or image files that are scanned by a scanning device. When the attachment files are sent by email, the attachment files are required to be in proper electronic format to be sent with an email. Accordingly, when an image is sent as an attachment to an email, it is necessary for the user to receive (or store) the image in the PC and to convert the image into data in electronic data format. In a conventional email system, image data is sent as follows: i) a manuscript image on a recording sheet is scanned by a scanner; ii) one image file is produced in a PC; iii) an email destination address is selected on an email program (application software); iv) the image file that was previously produced as an attachment file of an email through the email program is set. Following completion of the above processes, the scanned image data is stored as the attachment file with the email in the email server, and is sent from the email server when the user inputs a send request (or click a send button).

In the above procedure, there are drawbacks for users who are not familiar with the system protocol. One of the drawbacks is that it is not easy to follow the protocol. In addition, when a receiver of the image data does not have a facsimile machine, the above protocol is only way to send the image data. However, a user is nonetheless required to follow the all procedures described above.

In order to resolve the above drawbacks, a facsimile machine that has been developed is configured to convert image data outputted from an image reading device into data which is able to be attached to an email, and to send the converted image data to a designated email address as an email. See Japanese laid-open patent application publication number H10-257227 (Reference 1).

However, in general, a facsimile machine has a unique address (only a single identification code) even though multiple users use the facsimile machine. For example, Reference 1 above describes that a unique address that is set to one facsimile machine is always used as a source address (or user's address). Accordingly, when multiple users use one facsimile machine to send image data, people at the destination side (or receiver) cannot identify who in particular sent the image data. The receiver only knows that the image data was sent from the particular facsimile machine.

The present invention was overcome the above drawbacks, and is directed to an image reading device and a controlling program of the image reading device. With the image reading device, a user of the device at an email source side (or user's side) can be identified at the destination side.

### SUMMARY

In order to achieve the above subject, an image reading device of the invention is connected to a communication network, and converts image information read by an image information reading part into sent image information, and sends the sent image information over the communication network. The image reading device includes a controller configured to format source specific information that is added to the image information based on a user identification (ID) information, the source specific information for identifying a user of the image reading device on a destination side at which the sent image information is received. In the present invention, the source specific information is defined as any type of information that is useful for identifying the source or the user. The source specific information includes, for example, an email address, a source facsimile number, or TSI information with respect to the source or the user. The source specific information is not peculiar to the image reading device, rather is flexibly set in correspondence with the user.

With the above image reading device, people on the destination side (or receiver) can identify a user on a source side. Further, an image communication system is realized that includes a receiving device for receiving sent image information via a communication network with the image reading device. Additionally, user identification (ID) information for identifying a user might be input by conventional input means, such as a mouse, keyboard, touch panel screen, or voice-recognition device. The user ID information might be obtained from image information that is read by the image reading device.

The image reading device of the present invention further includes a user identification (ID) information memory part configured to store the user ID information; and a user information input part configured to receive input information configured with the user ID information or at least one item of the user ID information. Wherein the controller further includes a discerning part configured to discern whether or not the user ID information corresponding to the input information has been registered in the user ID information memory part, the user ID information that was input to the user information input part. The user information input part includes, for example, a card reader or a USB memory reader. Further, defined is information that is input to the user information input part and that is associated with the source specific information or the user ID information as the input information. Additionally, the user ID information is input to the user information input part as the input information, then is set as the source specific information.

The image reading device of the present invention further includes a sent image information producing part that converts the image information read at the image information reading part into the sent image information, and that adds the at least one item of the user ID information stored in the user ID information memory part as the source specific information to the sent image information.

Further, the controller is configured to register the user ID information that is received at the user information input part in the user ID information memory part when the discerning part discerns that the user ID information has not been registered in the user ID information memory part.

In order to solve the above problem, a memory medium of the present invention includes instructions for being executed by a controller of an image reading device that is connected to a communication network, the instructions for implementing the steps of: obtaining user identification (ID) information; discerning whether or not the obtained user ID information has been registered in a user identification (ID) information memory part; registering the obtained user ID information in the user ID information memory part when it is discerned that the ID information has not been registered; obtaining image information of a manuscript; converting the obtained image information into sent image information that is configured in a format in which the sent image information is able to be sent over the communication network; and reading source specific information corresponding to the user ID information obtained out of the user ID information memory part, adding the source specific information to the sent image information, and sending the sent image information externally through the communication network.

Also, an image reading device of the present invention includes an image information reading part configured to receive image information; a user information input part configured to receive user identification (ID) information; a user ID information memory part configured to store the user ID information received at the user information input part; and a control part configured to convert the image information received at the image information reading part into sent image information, and to format and add source specific information to the image information based on the user ID information for identifying a user of the image reading device on a destination side at which the sent image information is received.

With the image reading device and the controlling program of the present invention, people on an email destination side (or receivers) can identify a user on an email source side. Particularly, the image reading device reads a manuscript image, then converts it into image data in a proper format for sending as an email or facsimile. When the image data is attached to an email, the device sends the image data with an email address of the user. When the image data is sent by facsimile, the device sends the image data with transmitter subscriber identification (TSI) information. Therefore, the receiver is able to identify the user by the attached email address or the TSI information. With the controlling program, a computer for the image reading device is able to implement the following functions: reading an image information, converting the image information into image data, attaching user ID information with the image data, and sending the image data.

### BRIEF DESCRIPTION OF THE DRAWINGS

FIG. 1 is a functional block diagram of an image reading device in a first embodiment.

FIG. 2 is a block diagram illustrating hardware of the image reading device in the first embodiment.

FIG. 3 illustrates an appearance of the image reading device in the first embodiment.

FIG. 4 is a flow diagram illustrating an email sending operation by the image reading device in the first embodiment.

FIG. 5 is a functional block diagram of an image reading device in a second embodiment.

FIG. 6 is a block diagram illustrating hardware of the image reading device in the second embodiment.

FIG. 7 is a flow diagram illustrating a facsimile sending operation by the image reading device in the second embodiment.

FIG. 8 is a table illustrating user identification information written in an ID card for the image reading device in the first embodiment.

FIG. 9 is a table illustrating a header format of an email sent from the image reading device in the first embodiment.

FIG. 10 is a table illustrating user identification information written in an ID card for the image reading device in the second embodiment.

FIG. 11 is a functional block diagram of an image reading device in a third embodiment.

FIG. 12 is a block diagram illustrating hardware of the image reading device in the third embodiment.

FIG. 13 is a flow diagram illustrating an email sending operation by the image reading device in the third embodiment.

### DETAILED DESCRIPTION

Hereinafter, embodiments of the image reading device and the controlling program are described with reference to the drawings. The drawings schematically illustrate the invention for ease of understanding. It is noted that these embodiments are merely examples of the invention, and do not limit the scope of the attached claims.

### FIRST EMBODIMENT

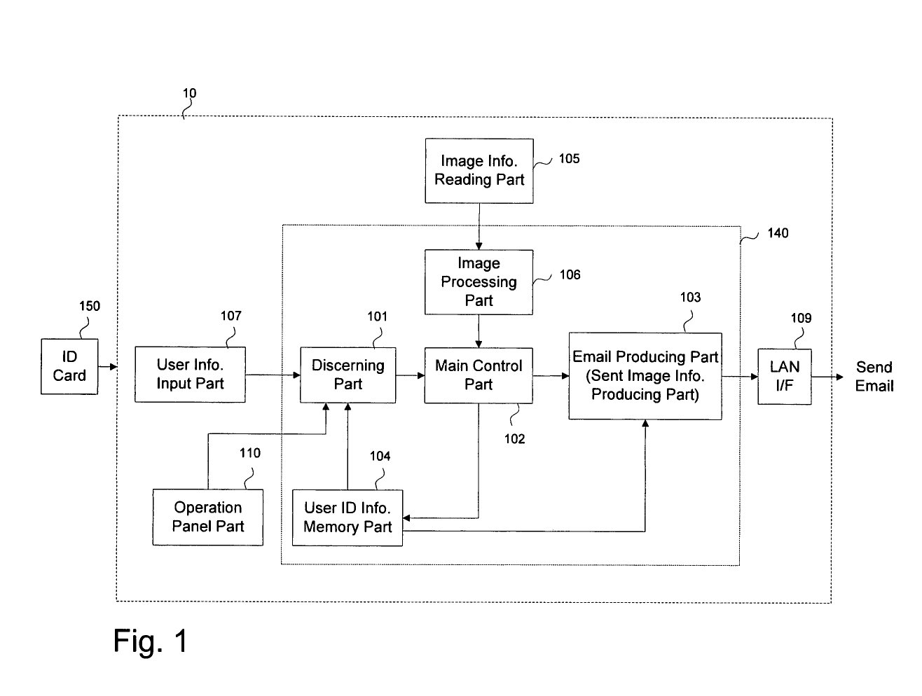

As FIG. 1 shows, an image reading device 10 is configured with an image information reading part 105, a user information input part 107, a local network interface (LAN I/F) 109, an operation panel part 110 and a controller 140. The controller 140 includes a discerning part 101, a main control part 102, an email producing part 103 (or a sent image information producing part), a user identification (ID) information memory part 104, and an image processing part 106.

The user information input part 107 reads either identification (ID) information (often referred as user ID information) of a user or a part of the ID information from an identification (ID) card 150 in the embodiment. The user ID information memory part 104 stores the user ID information. The image information reading part 105 scans a manuscript and reads image information from the manuscript. The discerning part 101 discerns whether or not the read user ID information has been stored in the user ID information memory part 104. The image processing part 106 implements predetermined image processing on the image information that is read by the image information reading part 105. The email producing part 103 converts the image information read by the reading operation performed by the above parts into image data in proper email format so that the image data can be sent as an email attachment.

The main control part 102 controls the entire processing of the image reading device 10, for example, reading out an email address from the user ID information memory part 104 and adding the address to an email. The LAN I/F 109 is configured as a communication interface with a computer (host computer). The LAN I/F 109 sends the produced emails out of the image reading device 10 and receives external controlling information, as the LAN I/F 109 is connected to the LAN. The operation panel part 110 is configured to input orders or instructions in correspondence with the user's operations.

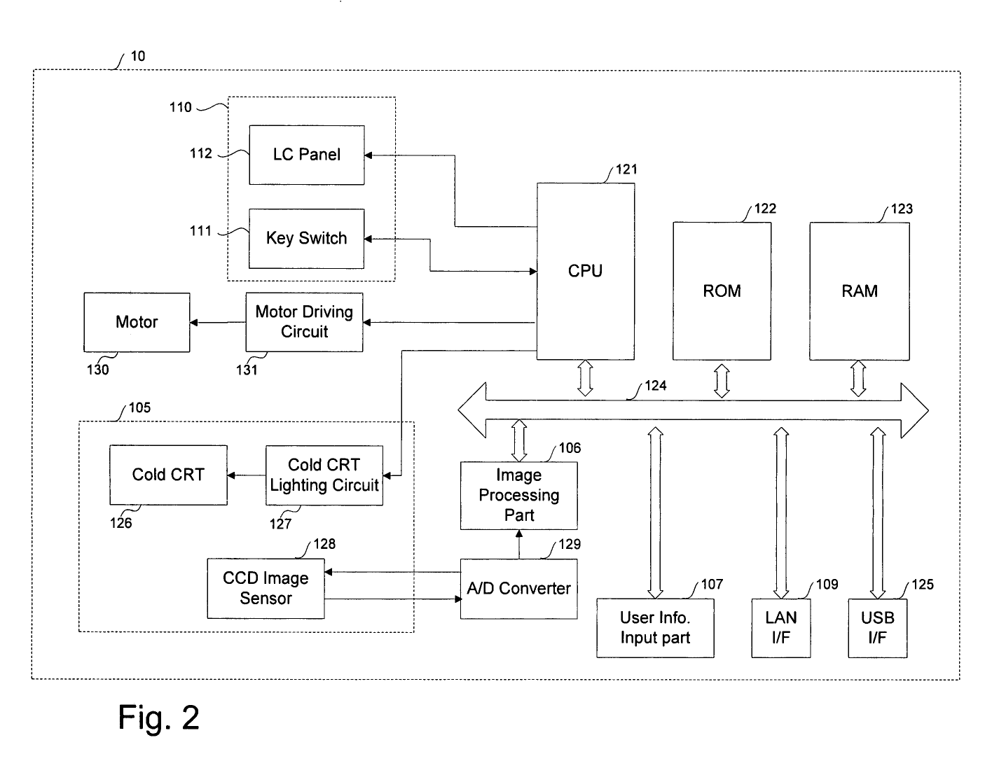

The LAN I/F 109 may be replaced with a universal serial bus interface (USB I/F), which is described later with reference to FIG. 2. The discerning part 101, the main control part 102 and the email producing part 103 are driven by programs stored in a read only memory 122, and are controlled by a central processing unit (CPU) 121. The user ID information memory part 104 is controlled by the CPU 121, and is positioned in a random access memory (RAM) 123.

As shown in FIG. 2, the image reading device 10 is configured with the CPU 121, the ROM 122, the RAM 123, a data control bus 124, the LAN I/F 109, a USB I/F 125, the image processing part 106, an analog/digital converter (A/D converter) 129, the image information reading part 105, a motor driving circuit 131, a motor 130, the operation panel part 110 and the user information input part 107.

The CPU 121 is a central processing unit that controls operations by each part of the image reading device 10. The CPU 121 reads programs out of the ROM 122 that is a nonvolatile memory, and executes them. The RAM 123 is a volatile memory that is used by the CPU 121 for the execution of the programs and data calculations. The LAN I/F 109 and USB I/F 125 are interfaces for communications with an external host computer via the data control bus 124. The LAN I/F 109 and the USB I/F 125 is configured to send read image data to the outside, to receive control information from the outside then to inform the CPU 121 of the information.

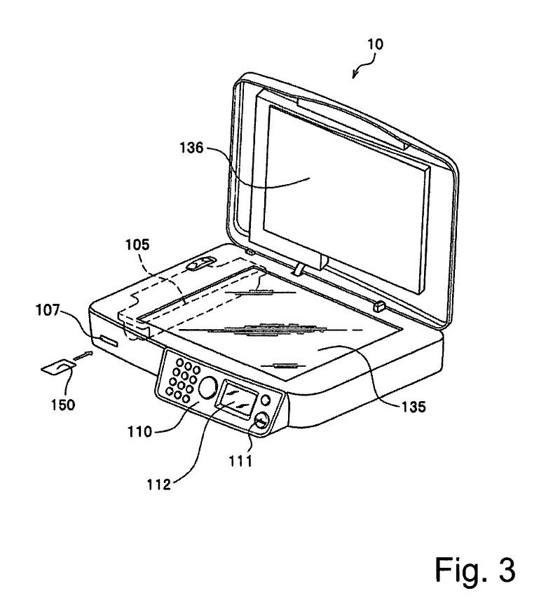

The user information input part 107 is a card reader that reads information registered in an identification card (ID card) 150, as shown in FIG. 3. The ID card 150 is used by the user who operates the image reading device 10. The card reader is used in this embodiment. However, other devices are also available instead of the card reader to the extent that the device is capable to read user ID information out of the user ID information memory medium including the ID card 150. For example, a USB memory reader is available where the user ID information memory medium is a USB memory. A liquid crystal (LC) panel 112 connects the CPU 121 and displays information, such as scanner status, according to commands from the CPU 121 for the user. A key switch 111 is a power switch that connects the CPU 121 and starts operations of the image reading device 10 when switched to an “ON” position.

The image information reading part 105 is configured with a cold cathode ray tube (cold CRT) 126 that is a light source (or optical source), a cold CRT lighting circuit 127 for lighting the cold CRT 126 based on a control of the CPU 121, and a charge-coupled device (CCD) image sensor 128 that collects reflected light from the manuscript and that photoelectrically converts the light into image voltage signals. An analog/digital (A/D) converter 129 converts the signals that were photoelectrically converted into digital data.

The image processing part 106 conducts image processing for the converted digital data by the A/D converter 129. Bit correction processing of light receiving elements and gamma correction processing are examples of the image processing performed by the image processing part 106. The motor driving circuit 131 drives the motor 130 based on the control by the CPU 121 and is configured to obtain photoelectrically converted image data of the entire manuscript by driving the image information reading part 105 along the manuscript in correspondence with the rotation of the motor 130.

FIG. 3 illustrates an appearance of the image reading device in the present embodiment. The image reading device 10 is configured with the manuscript platen 135, the manuscript cover 136, the image information reading part 105, the operation panel part 110, and the user information input part 107. The manuscript platen 135 and the manuscript cover 136 are installed in the image reading device 10. The manuscript platen 135 is composed of a transparent material, such as glass, pressing the manuscript against the manuscript platen 135, and thus, sandwiching the manuscript with the manuscript platen 135. The manuscript cover 135 is configured to swing and to have open and closed positions. The image information reading part 105 is configured to move (or slide) inside the image reading device 10 in order to scan the manuscript placed on the manuscript platen 135 from the bottom side. The user information input part 107 is configured to read information from the user ID card 150. The operation panel part 110 is configured with the LC panel 112 and the key switch 111.

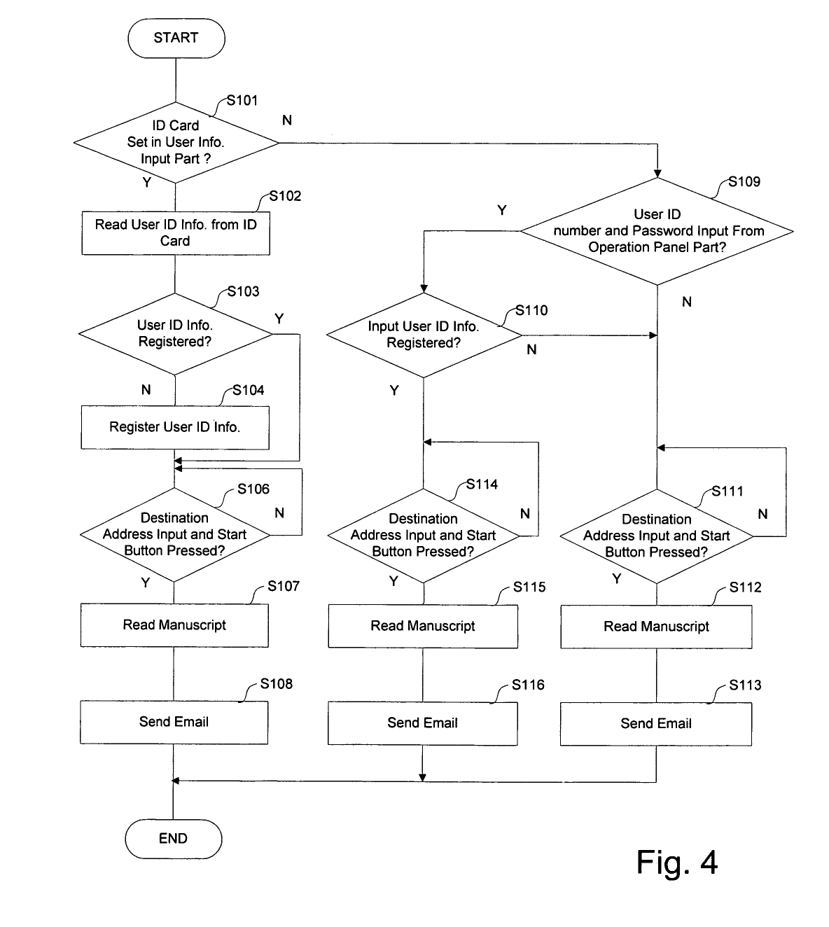

FIG. 4 is a flow diagram illustrating an email sending operation by the image reading device 10 in the present embodiment. Hereinafter, an email sending operation performed by the image reading device 10 of the present invention is described referring to FIG. 4 and FIG. 1. The operation is executed by the control of the CPC 121 based on the control programs stored in the ROM 122.

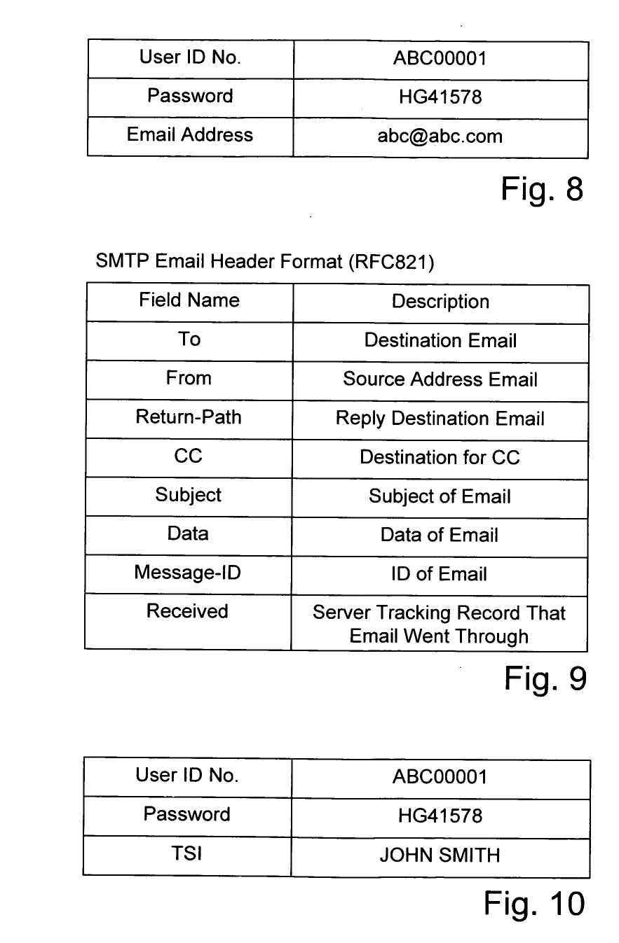

Initially, the controller 140 judges whether or not the ID card 150 has been inserted in the user information input part 107 (S101). Herein, it is assumed that the user ID number, password, and email address have been written in the ID card 150 as shown in FIG. 8. When the ID card 150 has been set in the user information input part 107 (YES), the user ID information is read out of the ID card 150, with the user ID information being composed of the user ID number, password information, and an email address of the user (S102, ID information reading function, or obtaining user ID information step).

The discerning part 101 discerns whether or not the read user ID information has been registered in the user ID information memory part 104 (S103, discerning function, or discerning step). Technically, the discerning part 101 searches for registered information that matches the user ID information in the user ID information memory part 104, and concludes that the user ID information has been registered when it detects data matching the user ID information. When the user ID information has not been registered in the user ID information memory part 104 (NO), the user ID information is registered in the user ID information memory part 104, the user ID information being composed of the user ID number, password information, and email address of the user that are read out of the ID card 150 inserted in the user information input part 107 (S104, user ID information memory function, or registering obtained user ID information step). On the other hand, when the read user ID information has already been registered (YES), no additional registration other than the correction of the user ID information is executed to the user ID information memory part 104, and processing proceeds to S 106.

The password information may be a password itself, or may be an alternative having information from which the password will be obtained later. For example, an encrypted password or an identification (ID) index is also available for the password, the ID index corresponding to a password that is stored in the device.

Next, it is confirmed whether or not a destination address has been input, and then whether or not the start button disposed on the operation panel part 110 has been pressed (S106). When YES, the image reading part 105 starts reading the manuscript placed on the manuscript platen 135 (S107: image information obtaining function, or obtaining image information step).

The image information reading operation is described hereinafter with reference to FIGS. 2 and 3. The CPU 121 instructs the motor driving circuit 131 to drive (or run) the motor 130, rotates the motor 130, and moves the image information reading part 105 along the manuscript platen 135. With the operation, the manuscript placed on the manuscript platen 135 is sequentially scanned by the CCD image sensor 128. By moving the image information reading part 105 up to the predetermined position, the entire image of the manuscript is read.

The image reading operation is executed by the CPU 121 instructing the cold CRT lighting circuit 127 to turn the cold CRT 126 on, then having the cold CRT 126 turned on, and by the CPU 121 instructing the image processing part 106 to start the processing. When the CRT 126 is turned on, the light generated at the CRT 126 illuminates the surface of the manuscript placed on the manuscript platen 135. The reflected light from the surface of the manuscript is reflected by a mirror, not shown, that is positioned within the image information reading part 105. The light reflected by the mirror is collected at the CCD image sensor 128 through a lens, not shown, then is photoelectrically converted by the CCD image sensor 128.

When receiving instructions for starting the processing from the CPU 121, the image processing part 106 activates the A/D converter 129 and CCD image sensor 128. The CCD image sensor 128 generates a voltage in correspondence with the amount of the received light. The A/D converter 129 converts the voltage receiving from the CCD image sensor 128 into a digital value. Through the processing, image information is converted into image (digital) data. The image data is executed with predetermined image processing, for example, a bit correction or the like, by the image processing part 106. The above description is directed to the reading operation.

After finishing the reading operation, the main control part 102 converts the image data processed at the reading operation into data that is able to be sent with an email in the email producing part 103 (image information converting function, or converting image information step). The main control part 102 reads an email address of the user in the user ID information stored in the user ID information memory part 104, the user ID information being previously read from the user ID card 150. The main control part 102 sets the read email address of the user as the source address (or the user ID information) for identifying the user, then sends the email including the image data and the email address.

In the embodiment, a simple mail transfer protocol (SMTP) is used for the email sending protocol. The SMTP is a very common protocol in the art and is defined in a document RFC821 with respect to the Internet technology and specifications, which was issued by the Internet Engineering Task Force (IETF). With the SMTP, a header of an email is regulated in a format shown in FIG. 9.

Based on the format, the email address is set in the row, “From,” in FIG. 9, as the email address read out of the user ID information memory part in FIG. 1, and corresponding to the ID information that is read out from the ID card 150. Similarly, a destination email address is set in the row, “To,” as the email address read out of the user ID information memory part 104. Also, date data is read out of a clock circuit not shown, and is set in the row, “Date.” The email is then formatted with the above header, and is sent (S108: sending function, or sending sent image information step). In the embodiment, SMTP is adopted. However, other protocols for sending emails through any kind of network including the Internet may be useful.

Referring back to FIG. 4, when the ID card 150 is not set in the user information input part 107 at S101 (NO), it is confirmed whether the user ID number and password have been input from the operation panel part 110 (S109: ID information obtaining function, or obtaining user ID step). When the user ID number and password have been input at S109 (YES), the discerning part 101 discerns whether or not user ID information corresponding to the input user ID number and password has been registered in the user ID information memory part (S110: discerning function, or discerning step).

When the user ID information has been registered at S110 (YES), it is confirmed whether or not a destination address has been input from the operation panel part 110 and whether or not the start button in the operation panel part 110 has been pressed (S114). When YES at S114, the image information reading part 105 starts the reading operation to read the manuscript placed on the manuscript platen (S115: image information obtaining function, or obtaining image information step). When NO at S114, the processing is repeated until the destination address input and pressing of the start button are confirmed. Because the reading operation for reading the manuscript is the same as the operation explained with reference to FIGS. 2 and 3, identical processing is omitted.

After finishing the reading operation, the email producing part 103 (sent image information producing part) converts the image data processed at the reading operation into data that is able to be sent with an email in the email producing part 103 (image information converting function, or converting obtained image information step). The main control part 102 reads the email address corresponding to the user ID number out of the user ID information memory part 104 as added information regarding the source (or the user). The main control part 102 sets the email address in the row, “From.” The main control part 102 sets the destination email address that is read out at S114 in the row, “To.” Also, date data is read out of the clock circuit, and is set in the row, “Date.” In the present embodiment, SMTP is adopted. However, other protocols used to send emails through any kind of network including the Internet may be used (S116: sending function, or sending step).

On the other hand, when NO at S 109, it is confirmed whether or not the destination address (or destination email address) has been input, and whether or not the start button in the operation panel part 110 has been pressed (S111). When YES at S111, the image information reading part 105 starts the reading operation to read the manuscript placed on the manuscript platen 135 (S112: image information obtaining function, or obtaining image information step). Because the reading operation for reading the manuscript is the same as the operation explained with reference to FIGS. 2 and 3, identical processing is omitted.

After finishing the reading operation, the main control part 102 converts the image data processed at the reading operation into data that is able to be sent with an email in the email producing part 103 (image information converting function, or converting obtained image information step). The main control part 102 reads an email address of the user out of the user ID information memory part in which the email address has been registered as a default (initial setting). The read email address is set in the row, “From,” and the destination email address input at S111 is set in the row, “To.” Date data is read out of the clock circuit, and set in the row, “Date.” The email is sent in SMTP (S113: sending function, or sending step). In the embodiment, SMTP is adopted. However, other protocols for sending emails through any kind of network including the Internet may be useful.

When the user ID information corresponding to the user ID number input at S110 has not been registered in the user ID information memory part at S110 (No), processing proceeds to S111, and similar processing described above is executed.

With the image reading device 10 of the present embodiment, the image information that is read by the image information reading part 105 is converted into in an email format, and is to be sent attached with the source address, namely an email address of the user, the email address being stored in the user ID information memory part. Accordingly, the image data can be sent with ease and the user who is on the source side may be identified by the receiver of the email who is on the destination side.

### SECOND EMBODIMENT

A second embodiment of the present invention is described. An image reading device 20 of the second embodiment has a function to send out the image information by facsimile. The appearance (outer shape) of the image reading device 20 is the same as that of the image reading device 10 in the first embodiment shown in FIG. 3.

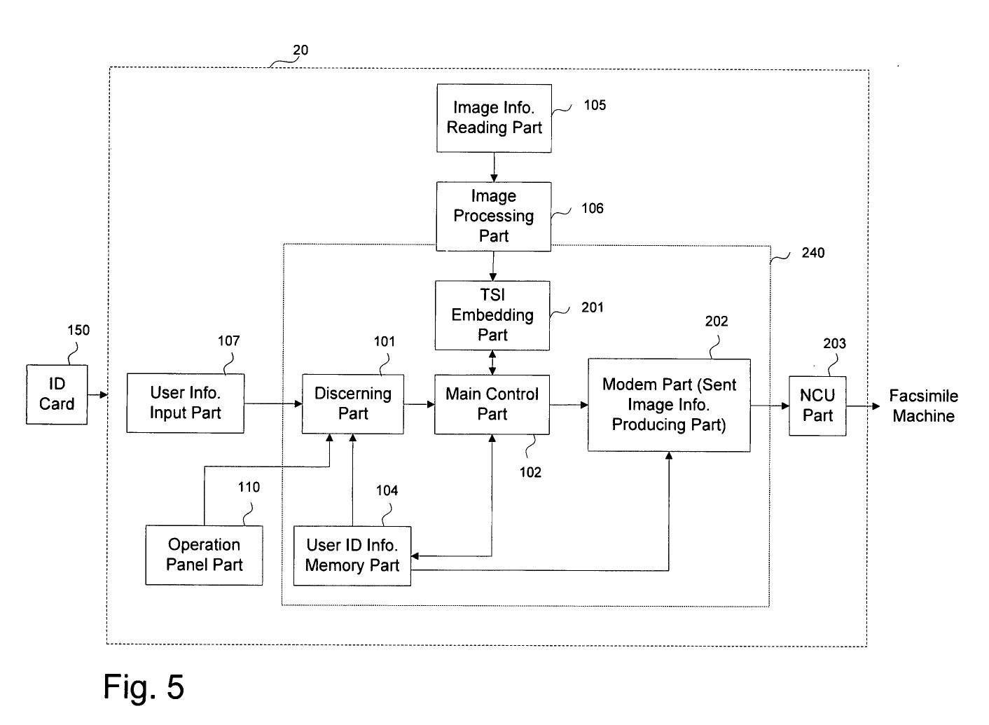

FIG. 5 is a functional block diagram of the image reading device 20 in the second embodiment. The image reading device 20 has a user information input part 107, a user ID information memory part 104, discerning part 101, an image information reading part 105, image processing part 106, a TSI embedding part 201, a main control part 102, a modem part 202, a network communication unit (NCU) part 203, and an operation panel part 110. The user information input part 107 is configured to read either ID information or a part of the ID information regarding the user on the source side out of the user ID card 150 according to the second embodiment. Based on the ID information, the user on the source side can be identified by people on the destination side. The user ID information memory part is configured to store the user ID information. The discerning part 101 is configured to discern whether or not the read ID information has been stored in the user ID information memory part. The image information reading part 105 is configured to scan the manuscript and to read out the image information. The image processing part 106 configured to execute a predetermined image processing on the read image information by the image information reading part 105 so that an image digital data is produced. The TSI embedding part 201 is configured to embed TSI information of the user into the image digital data on which the image processing has been executed. The main control part 102 is configured to control the entire device, such as to send the image information in which the TSI information is embedded to the modem part 202, together with reading the TSI information from the user ID information memory part and sending it to the TSI embedding part 201. The modem part 202, as a sent image information producing part, is configured to convert the digital data on which the image processing is executed into analog signals which are transferred through a communication network (telephone network in the embodiment). The NCU part 203 is configured to send the analog signals converted at the modem part 202 to the telephone network. The operation panel part 110 is configured as an interface with the user of the device. The discerning part 101, main control part 102, and TSI embedding part 201 are driven by programs stored in a ROM 122, and controlled by the CPU 121, which are described later. The user ID information memory part is controlled by the CPU 121, and is positioned in the RAM 123.

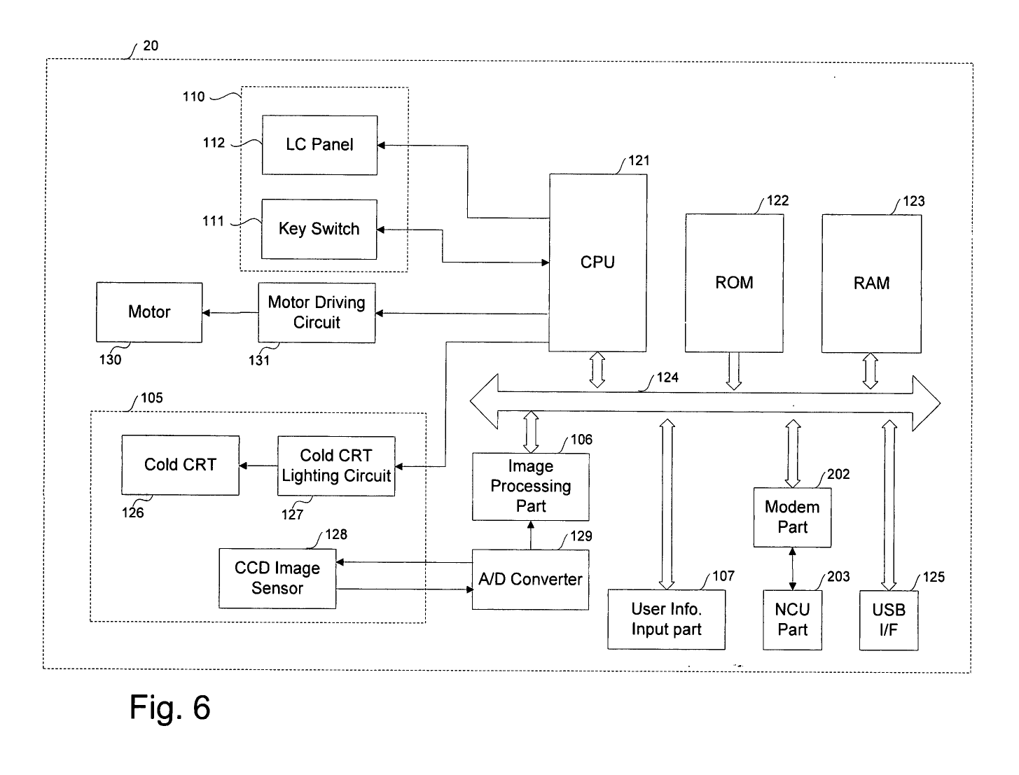

FIG. 6 is a block diagram illustrating hardware of the image reading device 20 in the second embodiment. The image reading device 20 is configured, in view of the hardware, with the CPU 121, the ROM 122, the RAM 123, a data control bass 124, a USB I/F 125, the modem part 202, the NCU part 203, a image processing part 106, an A/D converter 129, an image information reading part 105, a motor driving circuit 131, a motor 130, an operation panel part 110, and a user information input part 107.

The CPU 121 is a central processing device that controls operation of each part of the image reading device 20. The CPU 121 reads programs out of the ROM 122 that is a nonvolatile memory, and executes them. The RAM 123 is a volatile memory that is used by the CPU 121 for the executions of the programs and data calculations. The USB I/F 125 is an interface for communications with a host computer outside via the data control bus 124. The USB I/F 125 is configured to send image data that are read to the outside, and to receive control information from the outside, then to inform the CPU 121 of the information. The user information input part 107 is a card reader that reads information stored in the ID card 150. The ID card 150 is used by the user who operates the image reading device 20. The card reader is used in this embodiment. However, other devices are also available instead of the card reader to the extent that the devices are capable of reading out user ID information from the user ID information memory medium including the ID card 150. For example, a USB memory reader is used where the user ID information memory medium is a USB memory.

A liquid crystal (LC) panel 112 connects the CPU 121 and displays information, such as scanner status and settings, according to commands from the CPU 121 for the user. A key switch 111 connects the CPU 121 and informs the CPU 121 of status of each switch. The image information reading part 105 is configured with a cold CRT 126 that is a light source (or optical source), a cold CRT lighting circuit 127 for lighting the cold CRT 126 based on a control of the CPU 121, a CCD image sensor 128 that collects reflected light from the manuscript and that photoelectrically converts the light into image voltage signals. An analog/digital (A/D) converter 129 converts the signals that were photoelectrically converted into digital data. The image processing part 106 conducts image processing for the converted digital data by the A/D converter 129. Bit correction processing of light receiving elements and gamma correction processing are examples of the image processing performed by the image processing part 106. The motor driving circuit 131 drives the motor 130 based on control by the CPU 121, is configured to obtain photoelectrically converted image data of the entire manuscript by driving the image information reading part 105 along the manuscript in correspondence with the rotation of the motor 130. The modem part 202 converts digital data on which the image processing is executed into analog signals. The NCU part 203 is a circuit for sending the converted analog signals by the modem part 202 (or sent image information producing part) to the telephone network.

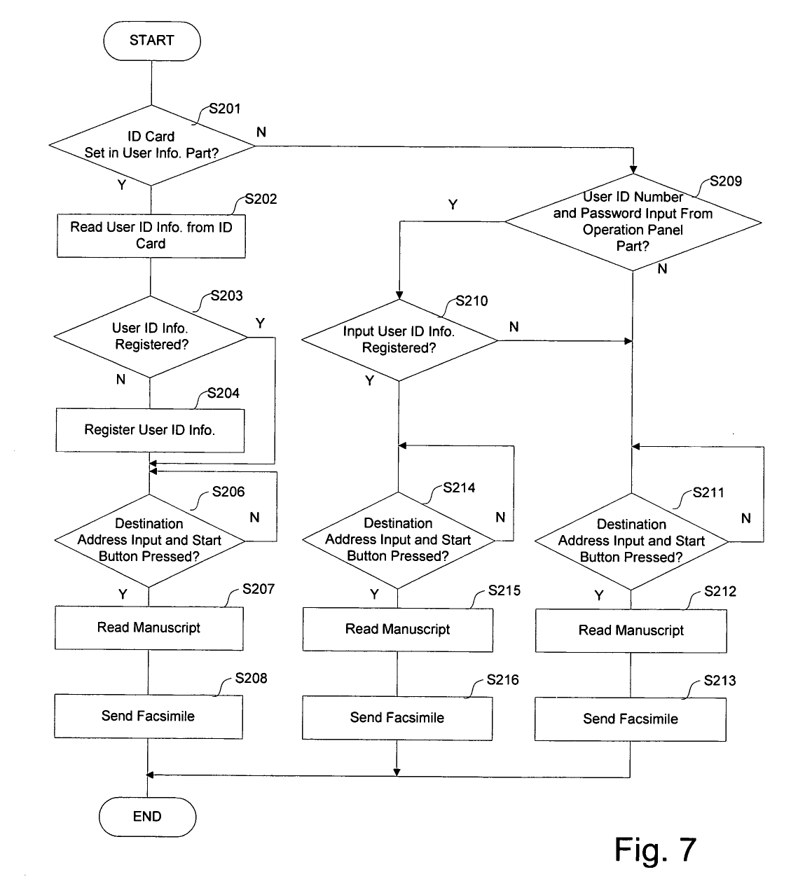

FIG. 7 is a flow diagram illustrating a facsimile sending operation by the image reading device 20 in the second embodiment. The facsimile sending operation by the image reading device 20 is described referring to FIG. 7 and FIG. 5. In the embodiment, it is assumed that the ID card 150 has stored a user ID number, a password, and TSI information of the user in advance, which are shown in FIG. 10. In the present embodiment, TSI information refers to source information or transmission affiliated information.

Initially, the controller 240 judges whether or not the ID card 150 has been set in the user information input part 107 (S201). When the ID card 150 has been set in the user information input part 107 (YES), the user ID information is read out of the ID card 150, with the user ID information being composed of the user ID number, password information, and TSI information of the user (S202, ID information obtaining function).

Next, the discerning part 101 discerns whether or not the read user ID information has been registered in the user ID information memory part 104 (S203: discerning function). When the user ID information has not been registered in the user ID information memory part 104 (NO), the user ID information of the user is registered in the user ID information memory part 104, with the user ID number being read from the ID card 150 that has been set in the user information input part 107 (S204: user ID information memory function). Then, processing proceeds to S206. When the user ID information has been registered at S203 (YES), no information is added to the user ID information memory part 104, and processing proceeds to S206.

The discerning part 101 discerns whether or not whether a destination address has been input from the operation panel part 110, and whether or not the start button disposed in the operation panel part 110 has been pressed (S206). When the destination address has been input and the start button has been pressed at S206 (YES), the reading operation starts at the image reading part 105 for reading the manuscript that is placed on the manuscript platen 135 (S207: image information obtaining function).

Here, the reading operation at the time is described referring to FIGS. 3 and 6. The CPU 121 instructs the motor driving circuit 131 to drive (or run) the motor 130, and has the motor 130 rotated, and moves the image information reading part 105 along the manuscript platen 135. With the operation, the manuscript placed on the manuscript platen 135 is sequentially scanned by the CCD image sensor 128. By moving the image information reading part 105 up to the predetermined position, the entire image of the manuscript is read.

The image reading operation is executed by the CPU 121 instructing the cold CRT lighting circuit 127 to turn the cold CRT 126 on, by having the cold CRT 126 turned on, and by the CPU 121 instructing the image processing part 106 to start the processing. When the cold CRT 126 is turned on, the light generated at the cold CRT 126 illuminates the surface of the manuscript placed on the manuscript platen 135. Light reflected from the surface of the manuscript is reflected by a mirror, not shown, that is positioned within the image information reading part 105. The light reflected by the mirror is collected at the CCD image sensor 128 through a lens, not shown, then is photoelectrically converted by the CCD image sensor 128.

When instructions for processing from the CPU 121 are received, the image processing part 106 activates the A/D converter 129 and CCD image sensor 128. The CCD image sensor 128 generates a voltage in correspondence with the amount of the received light. The A/D converter 129 converts the voltage received from the CCD image sensor 128 into a digital value. Through the processing, image information is converted into image (digital) data. The image data converted into digital data proceeds to a predetermined processing, for example, a bit correction or the like, by the image processing part 106. The above description is about the reading operation.

After finishing the reading operation, the main control part 102 embeds the TSI information in the image data that was processed at the above reading operation. Specifically, the TSI information of the user is read out of the user ID information memory part 104, the TSI information corresponding to the read ID information that was read out of the user ID card 150. The TSI information is converted into data that is able to be embedded in image data, then is embedded in the image data. Next, the image data including the TSI information of the user is converted into signals that are able to be sent by facsimile at the modem part 202 (image information converting function). The NCU part 203 controls the telephone network, (technically establishes an online status with the telephone network) so that the signals are sent by facsimile (S208: sending function). With respect to the facsimile sending method or protocol, any method or protocol is available as suggested by the international telecommunication union—telecommunication standardization sector (ITU-T).

When the ID card 150 has not been in the user information input part 107 at S201 (NO), it is confirmed whether or not a user ID number and a password have been input from the operation panel part 110 (S209). When the user ID number and password has been input at S209 (YES), the discerning part 101 discerns whether or not user ID information corresponding to the input user ID number and password has been registered in the user ID information memory part 104 (S210: discerning function). When the input user ID number and password matches the stored user ID information (YES), it is confirmed whether or not a destination address has been input from the operation panel part 110 and whether or not the start button on the operation panel part 110 has been pressed (S214). When the destination address has been input from the operation panel part 110 and the start button on the operation panel part 110 has been pressed (YES), the reading operation for reading the manuscript placed on the manuscript platen 135 starts (S215: image information obtaining function). The subsequent reading operation is identical to the operation described above referring to FIGS. 3 and 6. Therefore, the description of the operation is omitted in the embodiment.

After finishing the reading operation, the main control part 102 embeds the TSI information in the image data that was processed at the above reading operation. Specifically, the TSI information of the user is read out of the user ID information memory part 104 with the TSI information corresponding to the read user ID information that was read out of the user ID card 150. The TSI information is converted into data that is able to be embedded in image data, then is embedded in the image data. Next, the image data including the TSI information of the user is converted into signals that are able to be sent by facsimile at the modem part 202 (image information converting function). The NCU part 203 controls the telephone network so that the signals are sent by facsimile (S216: sending function). With respect to the facsimile sending method or protocol, any method or protocol as suggested by the international telecommunication union—telecommunication standardization sector (ITU-T) is available.

On the other hand, when the user ID information and password has not been input at S209 (NO), it is confirmed whether or not the destination address has been input from the operation panel part 110 and whether or not the start button on the operation panel part 110 has been pressed (S211). When YES, the reading operation of the image information reading part 105 starts so that the manuscript placed on the manuscript platen 135 is read (S212: image information obtaining function). The reading operation is identical to the operation described above referring to the FIGS. 3 and 6. Therefore, the description of the operation is omitted in the embodiment.

After finishing the reading operation, the main control part 102 reads the TSI information that has been registered as default (default of user ID information) out of the user ID information memory part 104, converts the TSI information into in a predetermined format, and adds the converted TSI information to the image data that was processed by the above reading operation. The main control part 102 converts the read image data in which the TSI information is embedded into data that is able to be sent by facsimile with the modem part 202. The NCU part 203 controls the telephone network and sends the image data by facsimile (S213: sending function). With respect to the facsimile sending method or protocol, a method or protocol suggested by ITU-T is used.

When the user ID information corresponding to the input user ID number does not match data registered in the user ID information memory part 104 (NO), processing proceeds to S211. Then the identical processing described above is executed.

With the image reading device 20 of the second embodiment, the image information that is read by the image information reading part 105 is converted into image data in the facsimile format, then is sent with the TSI information of the user that is stored in the user ID information memory part 104. Therefore, identification of the user of the source side at the destination side may be thus realized.

### THIRD EMBODIMENT

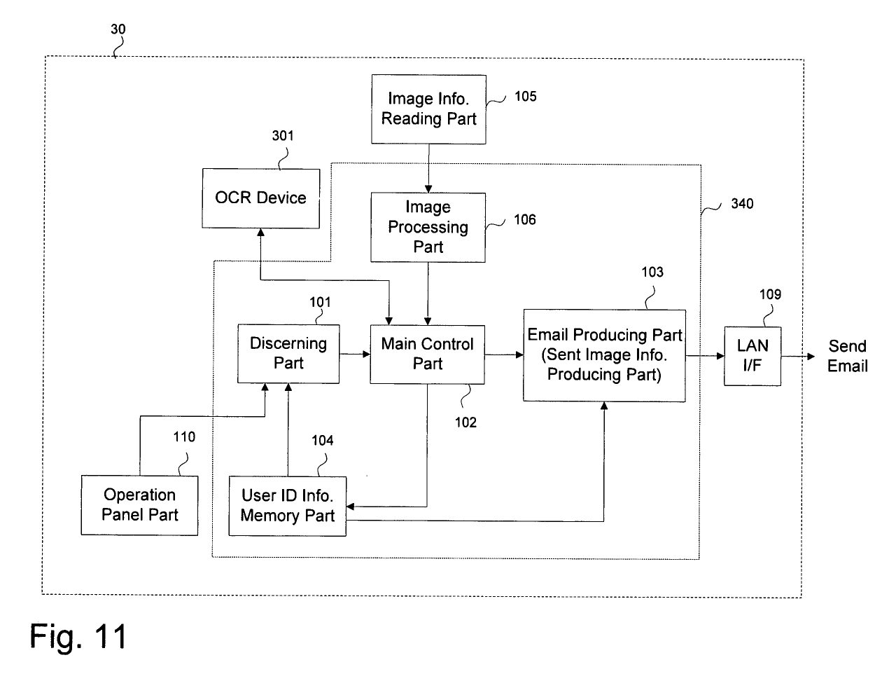

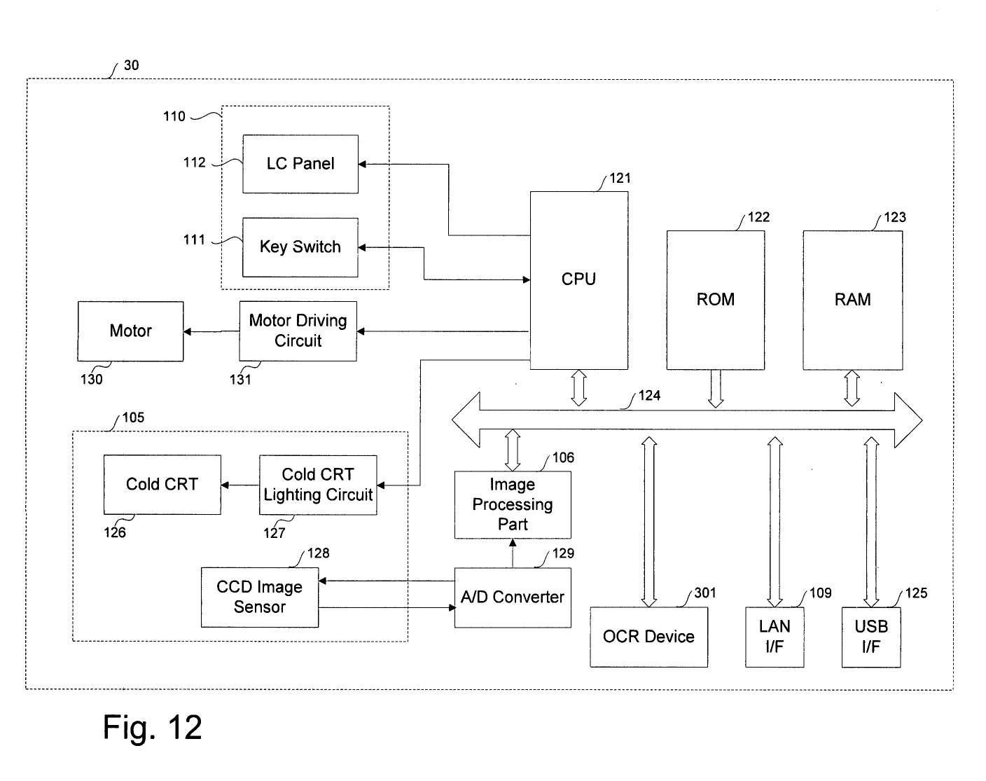

The third embodiment is described below. FIG. 11 is a functional block diagram of an image reading device 30 in a third embodiment. FIG. 12 illustrates a block diagram of hardware with respect to the image reading device 30 in the third embodiment. A difference in the first embodiment is that the image reading device 30 of the third embodiment does not have any parts or units corresponding to the user information input part 107 by which user information is read from a memory device, such as the ID card 150 shown in FIG. 3. Instead of a memory device, the user information is recognized by an optical character reader (OCR) device 301 from text information that comes from image data scanned by the image information reading part 105.

As FIG. 11 shows, the image reading device 30 includes an image information reading part 105, an image processing part 106, an OCR device 301, a user ID information memory part 104, a discerning part 101, and an email producing part 103 as a sent image information producing part. The image information reading part 105 scans a manuscript and reads image information from the manuscript. The image processing part 106 implements predetermined image processing on the image information that is read by the image information reading part 105. The OCR device 301 functions to recognize text information that is printed in a particular area of the image information with respect to the manuscript, then to read user ID information or part of the user ID information from the recognized text information. The discerning part 101 discerns whether or not the read user ID information has been registered in the user ID information memory part 104. The email producing part 103 converts the image information that is obtained by the above described parts into image data in format proper for the email so that the image data is able to be sent as an email over the Internet (communication network).

The main control part 102 controls the reading of an email address from the user ID information memory part 104 and the adding of the address to an email. The email producing part 103 is a sent image information producing part that produces an email. The LAN I/F 109 functions as a communication interface with a computer (host computer). The LAN I/F 109 is an interface for communicating with a computer that is a host machine, for sending the produced emails externally, and for being connected to the LAN through which controlling information from the outside is delivered. The LAN I/F 109 may be a USB I/F. The operation panel part 110 functions to input orders or instructions by the users. The image reading device 30 is configured with the above parts.

Among the above parts, functions of the image information reading part 105, image processing part 106, user ID information memory part 104, discerning part 101, main control part 102, email producing part 103, LAN I/F 109, and operation panel part 110 are identical to the embodiments that have been described. The discerning part 101, main control part 102 and the email producing part 103 are driven by programs stored in the ROM 122, and controlled by the CPU 121. The user ID information memory part 104 is controlled by the CPU 121 and is positioned in the RAM 123.

Hardware of the image reading device 30 shown in FIG. 12 is configured with the CPU 121, the ROM 122, the RAM 123, a data control bus 124, a LAN OF 109, a USB I/F 125, an image processing part 106, an analog/digital converter (A/D converter) 129, the image information reading part 105, a motor driving circuit 131, a motor 130, the operation panel part 110 and an OCR device 301. Additionally, each block other than the OCR device 301 has substantially the same function and the same operation as described in the first embodiment referring to FIG. 2.

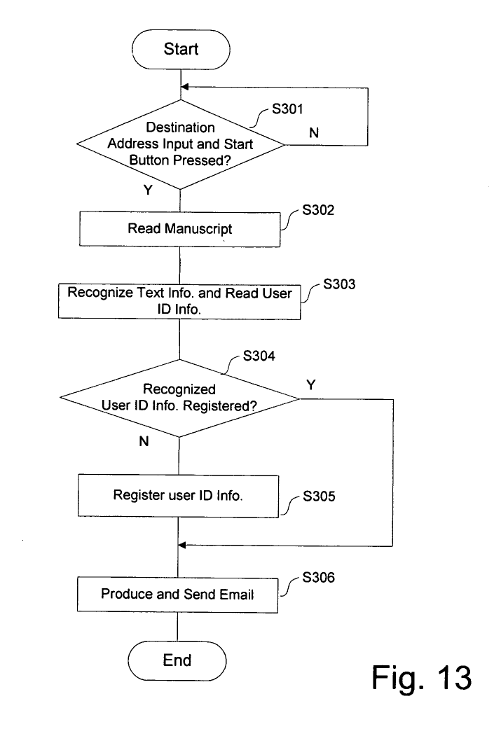

FIG. 13 is a flow diagram illustrating an email sending operation in the third embodiment. The email sending operations are described referring to FIGS. 12 and 13. Initially, it is confirmed whether or not a destination address has been input with the operation panel part 110, and whether or not the start button on the operation panel part 110 has been pressed (S301). When YES, the image information reading part 105 starts a reading operation for reading a manuscript placed on the manuscript platen 135 (S302: image information obtaining function). The reading operation is identical to the operation described for the first embodiment referring to FIGS. 2 and 3. Therefore, the detailed description is omitted.

With operation of the OCR device 301 and the CPU 121, a user ID information is recognized from text information that is described in a predetermined position in the image information of the read manuscript by the image information reading part 105 (S303: ID information obtaining function). In the present embodiment, it is assumed that user ID information or part of the user ID information is designed to be placed in the predetermined position of the manuscript. The user ID information is configured with a user ID number, a password, and an email address of the user. Generally, the user ID information is composed of alphanumeric characters. Therefore, the OCR device 301 correctly recognizes the user ID information on the manuscript under ordinary conditions where the manuscript does not include stains or typographical errors.

The discerning part 101 discerns whether or not the recognized user ID information has been registered in the user ID information memory part 104 (S304: discerning function). When NO (S304), the user ID information is registered in the user ID information memory part 104, with the user ID information being configured with the user ID number, password, and email address of the user, which are recognized by the OCR device 301 (S305: user ID information memory function). When the user ID information has been registered in the user ID information memory part 104 at S304 (YES), no additional registration other than the correction of the user ID information is executed at the user ID information memory part 104.

The main control part 102 converts the image data processed at the reading operation into data that is able to be sent by email in the email producing part 103 (image information converting function). The main control part 102 reads out the email address in the user ID information registered in the user ID information memory part 104 as a source address (or the user), the user ID information recognized by the OCR device 301. The main control part 102 sets the read email address as the source address for identifying the user, and sends the email (S306: sending function). The detailed operation for sending the email is identical to the first embodiment described previously.

With the image reading device 30 of the present embodiment, the image information that is read by the image information reading part 105 is converted into in an email format. The user ID information is recognized from the text information included in the image information by the OCR device 301, and is registered in the user ID information memory part 104. An email address of the user is read out of the registered user ID information, and is attached to the converted image data. Then, the converted image data with the email address of the user is sent. Accordingly, an image reading device 30 having the advantages is realized: user ID information can be attached without a user information input part 107, image data can be easily sent externally, and a user on the source side can be identified on the destination side.

(Variations) The scope of the invention is not limited to the above embodiments. Variations or modifications of the invention are available. For example, an email system is described for the image data sending system in the third embodiment. However, a facsimile system is also useful as described in the second embodiment.

The OCR device 301 is used for recognizing text information in the manuscript in the third embodiment. However, a bar code reader disposed in the image information reading part 105 is also useful for recognizing the user ID information when the user ID information is written in one dimensional or two dimensional bar code. In such a structure, the bar code reader may be disposed in the image information reading part 105.

With the above variations, a user on the source side may be identified by people on the destination side as is the first to third embodiments.

In the invention, many types of memory media, such as an ID card, USB memory, a hard disk drive (especially portable disk) or the like, may be available. Many types of information reading devices, such as an ID card reader or a USB memory reader, may be available as memory medium reading devices. Input information may be defined as any type of information with respect to the user ID information that is input by the user information input part 107. Additionally, not only entire user ID information but part of the user ID information also may be available for the input information. When the user ID information is configured with multiple items, see FIGS. 8 and 10, one of the items may be used as the input information.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. An image reading device that is connected to a communication network, that converts image information read by an image information reading part into sent image information, and that sends the sent image information over the communication network, the image reading device comprising:
a controller configured to format source specific information that is added to the image information based on user identification (ID) information, the source specific information for identifying a user of the image reading device on a destination side at which the sent image information is received.

2. The image reading device of claim 1, further comprising:
a user identification (ID) information memory part configured to store the user ID information;
a user information input part configured to receive input information configured with the user ID information or at least one item of the user ID information, wherein
the controller further comprises a discerning part configured to discern whether or not the user ID information corresponding to the input information has been registered in the user ID information memory part, the user ID information that was input to the user information input part.

3. The image reading device of claim 2, wherein
the controller further includes a sent image information producing part that converts the image information read at the image information reading part into the sent image information, and that adds the at least one item of the user ID information stored in the user ID information memory part as the source specific information to the sent image information.

4. The image reading device of claim 2, wherein
the controller is configured to register the user ID information that is received at the user information input part in the user ID information memory part when the discerning part discerns that the user ID information has not been registered in the user ID information memory part.

5. The image reading device of claim 3, wherein
the sent image information is configured in email format, and the sent image information producing part adds an email address as the source specific information to the sent image information, the email address being the at least one item of the user ID information stored in the user ID information memory part.

6. The image reading device of claim 3, wherein the sent image information is configured in facsimile format, and the sent image information producing part adds transmitter subscriber identification (TSI) information as the source specific information to the sent image information, the TSI information being the at least one item of the user ID information stored in the user ID information memory part.

7. The image reading device of claim 5, wherein
the controller is configured to read the email address that is stored as the source specific information out of the user ID information memory part, and to add the email address as the source specific information to the sent image information when the discerning part discerns that the email address, corresponding to the input information that is input at the user information input part, has not been registered in the user ID information memory part.

8. The image reading device of claim 6, wherein
the controller is configured to read the TSI information that is stored as the source specific information out of the user ID information memory part, and to add the TSI information as the source specific information to the sent image information when the discerning part discerns that the TSI information, corresponding to the input information that is input at the user information input part, has not been stored in the user ID information memory part.

9. The image reading device of claim 2, wherein the user information input part is a memory medium reading device configured to read information out of a memory medium.

10. The image reading device of claim 9, wherein the memory medium is an ID card, and the memory medium reading device is an ID card reader.

11. The image reading device of claim 9, wherein the memory medium is a USB memory, and the memory medium reading device is a USB memory reader.

12. The image reading device of claim 1, wherein the user information input part is a keyboard that enables the user to input information.

13. The image reading device of claim 1, wherein the user information input part is an optical character reader (OCR) device.

14. The image reading device of claim 1, wherein the user information input part is a bar code reader that recognizes information from a bar code in the image information.

15. A memory medium comprising instructions for being executed by a controller of an image reading device that is connected to a communication network, the instructions for implementing the steps of:
obtaining user identification (ID) information;
discerning whether or not the obtained user ID information has been registered in a user identification (ID) information memory part;
registering the obtained user ID information in the user ID information memory part when it is discerned that the ID information has not been registered;
obtaining image information of a manuscript;
converting the obtained image information into sent image information that is configured in a format in which the sent image information is able to be sent over the communication network; and
reading source specific information corresponding to the user ID information obtained out of the user ID information memory part, adding the source specific information to the sent image information, and sending the sent image information externally through the communication network.

16. An image reading device, comprising:
an image information reading part configured to receive image information;
a user information input part configured to receive user identification (ID) information;
a user ID information memory part configured to store the user ID information received at the user information input part; and
a control part configured to convert the image information received at the image information reading part into sent image information, and to format and add source specific information to the image information based on the user ID information for identifying a user of the image reading device on a destination side at which the sent image information is received.

17. The image reading device of claim 16, further comprising
a discerning part in communication with the user information input part and configured to discern whether or not the user ID information received at the user information input part has been registered in the user ID information memory part, and to cause the user ID information to be registered in the user ID information memory part if the user ID information has not already been registered.

18. The image reading device of claim 16, wherein
the sent image information is configured in email format, and the control part adds an email address of the user as the source specific information to the sent image information.

19. The image reading device of claim 16, wherein
the sent image information is configured in facsimile format, and the controller adds transmitter subscriber identification (TSI) information of the user as the source specific information to the sent image information.

20. The image reading device of claim 16, wherein
the user ID information input part is an optical character recognition (OCR) device that is configured to recognize the source specific information from a scanned image information of a manuscript in a predetermined position, and the control part adds the source specific information to the sent image information.
